(19) United States
(12) Patent Application Publication
(10) Pub. No.: US 2012/0209645 A1
(43) Pub. Date: Aug. 16, 2012

(54) SYSTEM AND METHOD FOR PROVIDING DATA RELATING TO BUSINESS EVENTS WITHIN BUSINESS PROCESSES

(75) Inventors: Roger Zacharias, Bad Nauheim (DE); Nico Vom Hagen, Bad Nauheim (DE)

(73) Assignee: WINCOR NIXDORF INTERNATIONAL GMBH, Paderborn (DE)

(21) Appl. No.: 13/500,579

(22) PCT Filed: Sep. 22, 2010
(86) PCT No.: PCT/EP2010/063988

§ 371 Date: Apr. 5, 2012

(30) Foreign Application Priority Data
Oct. 7, 2009 (DE) 10 2009 048 591.0

(51) Int. Cl. G06Q 10/06

(52) U.S. Cl. 705/7.11

(57) ABSTRACT

The invention proposes a central data service unit (ZDE), which provides data (DA-Dm) relating to business events (GE1-GEn) that occur in a business process for data consumers (KA-Km) when requested or required. The data is provided in a processed form (F*) and via a defined output interface (OUT), and therefore the proposed system (SYS) can be scaled very easily with respect to the growing number of consumers and the volume of data that occurs.

### CROSS-REFERENCE TO RELATED APPLICATIONS

This application is a National Stage of International Application No. PCT/EP2010/063988, filed Sep. 22, 2010, and published in German as WO 2011/042305 A1 on Apr. 14, 2011. This application claims the benefit and priority of German Application 10 2009 048 591.0, filed Oct. 7, 2009. The entire disclosures of the above applications are incorporated herein by reference.

### BACKGROUND

This section provides background information related to the present disclosure which is not necessarily prior art.

1. Technical Field

The invention relates to a system for providing data, i.e. data containing information about business events that occur within a business process. The invention also relates to a method which is carried out by the system.

2. Discussion

In many technical applications, business processes need to be managed and monitored in order to be able to control on an event-driven basis the technical procedures, for example, in a point-of-sale system or the like. In general terms, a business process refers to the sequence of individual actions or steps that are carried out to achieve a business or operational objective. Unlike projects, business processes can be performed more than once. In addition, a business process can itself be part of another business process or contain or initiate other business processes. What are known as “business events” also occur within a business process. The term “business event” refers in particular to the state that arises before or after a particular step.

A system and a method for supporting the creation or generation of business processes is known from DE 102007046049A1. The solution described in this document relates in particular to determining an optimum business process model for a given business, in particular compiling a business element list from business process templates. This document is not concerned with the management or occurrence of business events. It is desirable, however, that business events that occur within a business process can also be managed as efficiently as possible by technical means.

To illustrate the initial situation for the invention, reference is made below to FIGS. 1 and 2, which reflect the current prior art:

FIG. 1 shows in a schematic diagram a business process GP and the individual elements thereof, and a plurality of data consumers K, which are meant to be informed about business events that occur. The business process GP may, for example, relate to managing an amount of available cash in a point-of-sale system, such as is illustrated in FIG. 2. People KA and also system components KB, KC, KD to KN are considered to be data consumers K. Usually, a business process GP comprises individual business events, which may occur within the running business process. For instance in this case, the business events GE1, GE2, GE3 to GEZ. A business function FKT is normally executed in the transition from one business event to the next (see, for example, the transition from GE1 to GE2). This may be a function performed by a person, for instance determining an amount of cash currently available by counting the cash that is present. The person assumes a specific role R in performing the function, for instance the role of cashier in this case. A business function FKT can also be executed by a technical device, for instance sending an order and the like. Input data DE, for example relating to the number of notes and/or coins that are present, is normally required in order to execute a business function. A function may then supply certain output data DA, such as, for example, the parameters “amount”, “denomination” etc. for an order that needs to be implemented. A business process of this type is described later with reference to FIG. 2.

As FIG. 1 shows, usually the individual business events GE1, GE2 to GEZ that occur are transmitted directly to the consumer(s) affected by the event. In the example shown here, the consumer KA is informed directly of the occurrence of business events GE1 and GE2. To do this, data containing information about each business event that occurs is transferred for the relevant consumer. In the example shown, the consumer KB, which may be a server, likewise receives the data about business events GE1 and GE2. On the other hand, another consumer, namely the server KD, receives data from the occurring business events GE2, GE3 and/or GE4. This means that for each event that occurs, data processing and data transmission must be tailored to suit the consumer(s) concerned. Specifically, this can mean compliance with certain formats and/or transmission standards used by the consumers. This in turn means that implementing a conventional solution of this type involves a high level of technical complexity and hence high costs.

FIG. 2 shows by way of example the procedure for a typical business process GP that is carried out in a point-of-sale system. The business process comprises a plurality of business events 100, 200, 300 etc., which are represented here by irregular hexagon symbols, and functions 110, 210, 310 etc., which are represented by rectangles with rounded corners. In addition, logical operations 220 and 520 need to be included, which are represented here by circular symbols. Furthermore, the business process GP also comprises data inputs and data outputs, which are represented by rectangular symbols. Specific functions, such as function 110 here, for instance, can be assigned specific roles, e.g. here the role or person of cashier.

The business process shown in FIG. 2 is explained in detail below:

The business process GP begins with the business event 100, which specifies the time of the daily order for cash in the form of notes and/or coins for stocking the point-of-sale system. This is followed by a function 110, in which the amount of cash currently available is checked. This function is carried out by the cashier. A data input 101, which contains the number of notes and/or coins counted in the available cash, is made for this function. The data output 102 is obtained as a result from function 110 and gives the data for the amount of cash currently available in the point-of-sale system or cashpoint. This leads to the business event 200, which signifies that the amount of cash currently available has been determined. The function 210 is executed next, which involves a decision over whether or not an order for additional cash is necessary. Parameters, for instance delivery days, insurance limit for the maximum possible order or logistics threshold for the maximum possible order, are provided as the data input 202. The change in the amount of available cash from an earlier time period can also be used as an additional data input 203. Function 210 can be executed using these data inputs, whereby as a result of a logical operation 220, or evaluation, performed on the data, either the business event 300 or the business event 300* takes place. Business event 300 means that an order for more cash is needed. Business event 300*, on the other hand, means that no order is needed at that time.

If business event 300 occurs, function 310 follows, which involves determining the actual requirement. As input data, the change in the amount of available cash from the preceding time is again included in block 301. Data relating to the allowed delivery days, insurance limit etc. is defined as the data block 302. Additional data 303 can, for example, define parameters that indicate special events, for instance festivals or major events etc. The function 310 produces as a data output the information 304 relating to the supply and removal of cash per cash till or cashpoint. Function 310 is then followed by the business event 400, which indicates that the requirement has been determined. Then follows function 410, which relates to creating a specific order for the cashpoint concerned. Information relating, for instance, to the order channels and similar data are included in the data input 401. The information about the order for each order channel is then produced as the data output (see block 402).

This then results in the business event 500, which indicates that the store order has been created. This is followed by function 510, which involves sending the order. Once the order has been sent, the following business events may occur as a result of the operation 520: business event 600, which indicates that the order had been sent; event 600*, which indicates that an order is notified; and event 600**, which indicates that the order is completed.

The business process GP shown here therefore relates to handling the cash inventory and ordering cash in a point-of-sale system or cashpoint. The invention is based in particular on business processes of this type, but is intended to be applicable to any business processes.

In the prior art, as was illustrated in FIGS. 1 and 2, the data relating to each business event that occurs is transferred individually and directly to the relevant consumers in the required formats or transmission forms. This results in a high level of technical complexity, however.

### SUMMARY OF THE INVENTION

Hence it is an object of the invention to propose a system and a method for providing data relating to information on occurring business events that enable the largest possible number and variety of consumers to retrieve the data they require at any time. The proposed system and method shall also be scalable in order to be able to satisfy, efficiently, increasing demands in terms of the number of consumers and/or the volume of incoming data.

It is accordingly proposed that the system comprises a central data service unit, which receives on the input side, input data about occurring business events, and processes this input data in order to form output data therefrom, which is then provided on the output side by means of a definable data output interface for retrieval by external data consumers. In the method according to the invention, the following steps are carried out in a central data service: receiving input data about occurring business events; processing the input data for storage in the database and storage of same; and forming and providing output data for retrieval by external data consumers.

Hence the invention proposes that all the input data relating to business events that occur is processed at a central point or within a central data service, and is provided for retrieval via at least one data output interface. Thus instead of data being transferred on a case-by-case basis for each individual business event that occurs, a central data service is created for all the business events, and the data about the business events that occur is provided in a centrally processed form via at least one data output interface.

Input data is received and collected in the central data service preferably in a push transfer or transmission, i.e. the input data is transmitted automatically from the business functions to the central data service as soon as a new business event occurs. This is done, for instance, by a “publish-subscribe” mechanism. On the output side, the processed data is again provided centrally, preferably by configuring a standardized data output interface, via which interface, external data consumers can gain access as required and can retrieve the data relating to the occurring business events. This is preferably done in a pull transmission.

### BRIEF DESCRIPTION OF THE DRAWINGS

The invention is described in greater detail below based on an embodiment and with reference to the attached drawings, which show the following schematic diagrams:

The drawings described herein are for illustrative purposes only of selected embodiments and not all possible implementations, and are not intended to limit the scope of the present disclosure.

FIG. 3 shows in a function diagram the configuration of a central data service;

FIG. 4 shows in a block diagram the structure of a system according to the invention comprising a central data service unit; and

FIG. 5 shows in a flow diagram the steps of a method according to the invention.

Corresponding reference numerals indicate corresponding parts throughout the several views of the drawings.

### DETAILED DESCRIPTION OF THE PREFERRED EMBODIMENTS

Example embodiments will now be described more fully with reference to the accompanying drawings.

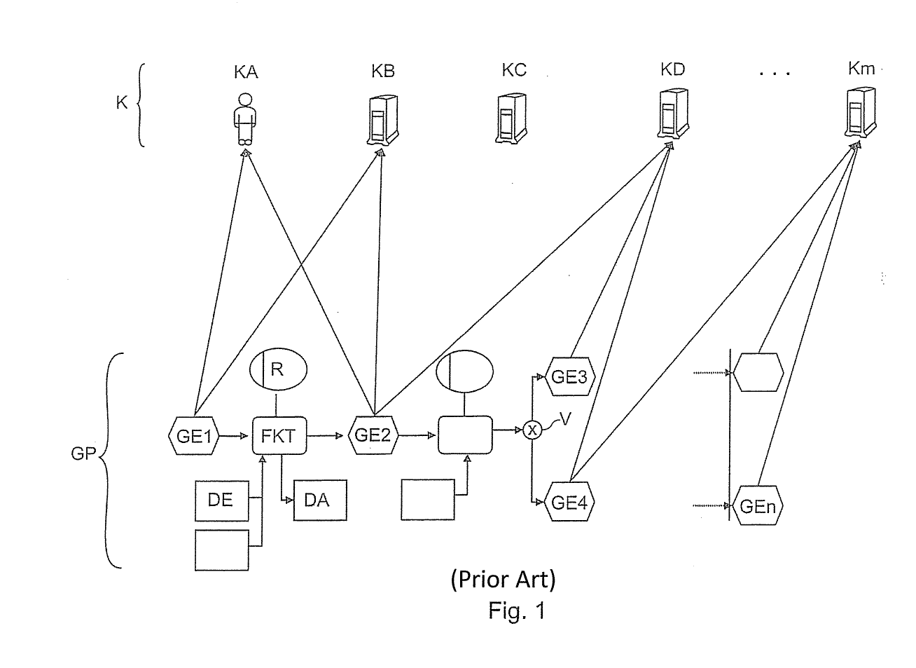

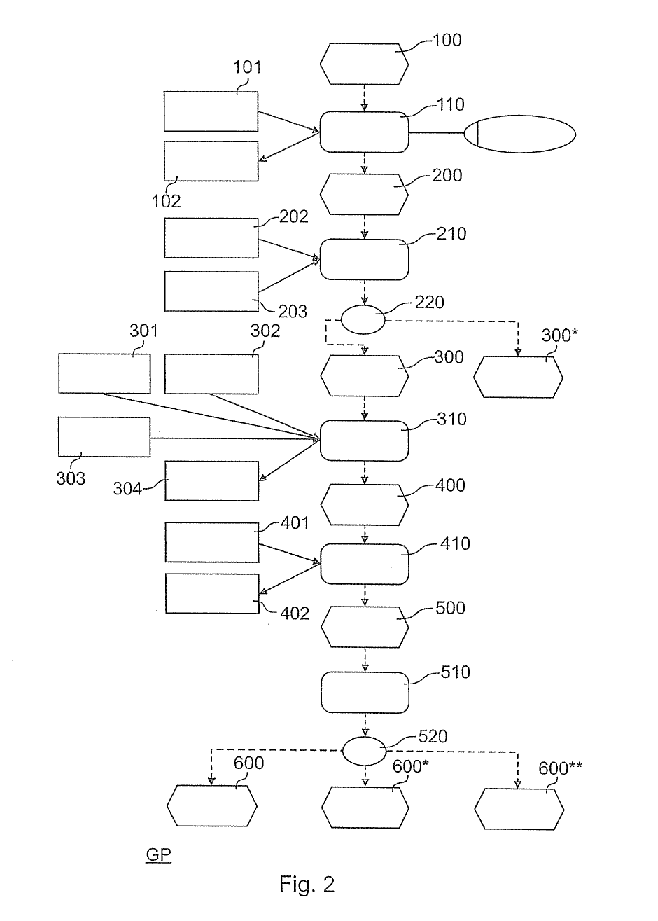

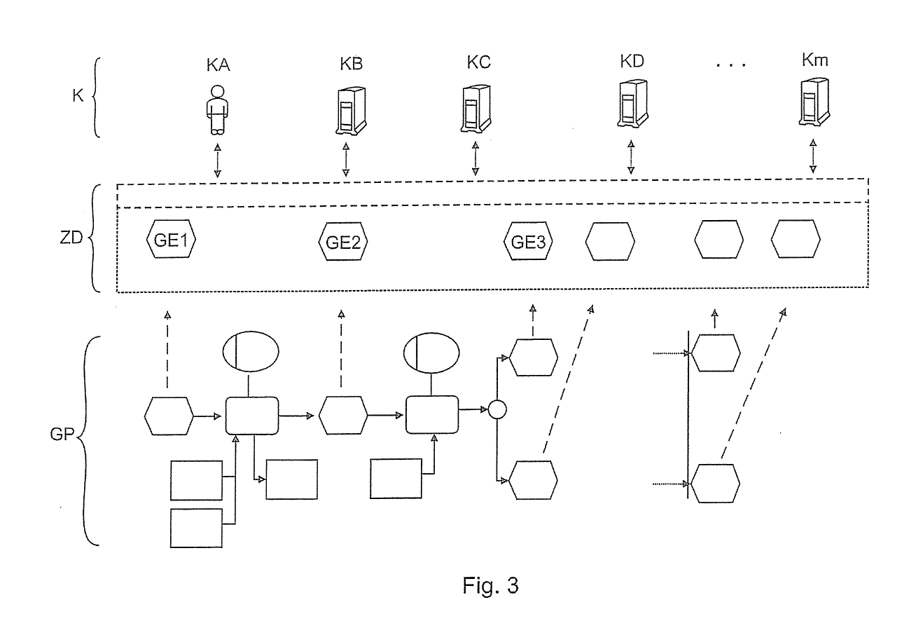

FIG. 3 shows in a schematic diagram the configuration of a central data service ZD, which is created between the consumers K and the relevant business process GP. In contrast with FIG. 1, it is clear that the central data service ZD acquires or collects centrally all, or as many as possible, of the events GE1, GE2, GE3 . . . that occur in the business process GP, and then provides them in a processed form for retrieval by the data consumers KA, KB, KC . . . KM. It is also evident from FIG. 3 that the proposed solution can be scaled very easily, in particular with respect to growth in data consumers K. The central data service has in particular the advantage that data can be output and/or retrieved via a definable interface.

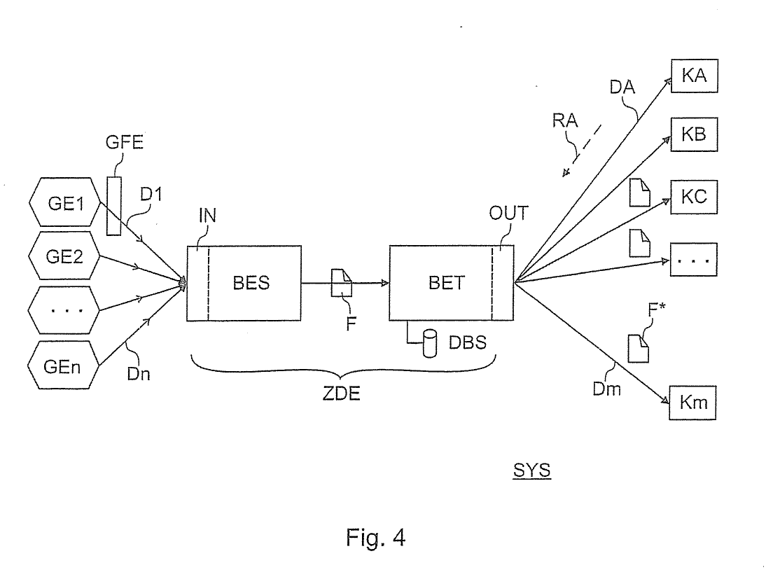

FIG. 4 shows in a schematic diagram the structure of a system SYS comprising a central data service unit ZDE, which receives on the input side, input data D1-Dn about occurring business events GE-GEn, and which, after processing the data, provides on the output side, suitable output data DA-Dm for retrieval by the data consumers KA-Km. The central data service unit ZDE is connected on the input side via a suitable interface IN to node points, in particular to business function units GFE, in order to receive input data D1-Dn about occurring business events GE1, GE2 . . . GEn. The central data service unit ZDE in particular comprises for this purpose a first module BES, which is connected to the data input interface IN and receives and processes the input data D1-Dn. Data processing also includes converting the data into a definable format F and attaching add-on data or metadata, such as a time stamp and the like.

The central data service unit ZDE also comprises a second module BET, which is connected to the first module BES and is in turn connected to the data output interface OUT. The second module forms output data from the processed data coming from the first module BES and then provides this output data for the relevant data consumers KA, KB . . . . For example, output data DA is provided for the consumer KA, and this data is then transferred when the consumer KA makes a request RA. This output data DA may contain, for example, information about the occurring business event GE1 and also the occurring business event GE2 (see FIG. 1). The output data is not supplied automatically on an event-driven basis, however, but is held available for retrieval via the output interface OUT. This means that the output data relevant to a particular data consumer can be retrieved by this data consumer as required.

The output data DA-Dm is preferably provided in a specific format F*, which is also defined to suit the output data interface OUT. The second module BET also comprises a database DBS, in which the processed input data and/or the output data formed therefrom is stored for later retrieval.

The two modules BES and BET shown in FIG. 4 can also be realised in one unit. In the drawing, however, it is preferred to show two modules BES and BET in order to illustrate at least the logical differentiation more clearly.

The input data D1-Dn contains information on the occurring business events GE1-GEn and also data comprising the following parameters or attributes in particular: a clear identifier or ID, a version number, a generation date, a business transaction number, runtime parameters, user data and/or client data. The scope of the supplied input data D1-Dn is determined in particular by the business function unit GFE and the occurring business event. In the first module BES, further data, such as time stamps or the like, can also be added. A feature of the first module BES is to provide a standardised data input interface IN in order to enable a central interface between the unit ZDE and existing systems (e.g. point-of-sale systems).

Inside the first module, which can also be called a business event service, the input data D1-Dn is processed and/or formatted. Using add-on data, such as time stamps, to expand or enrich data, enables more comprehensive temporary storage in the second module BET, which is connected to the output of the first module. This second module BET can also be called a business event topic, and in particular provides the data output interface for access by any consumers. The second module BET not only processes the output data DA-Dn but also, by storing this data, provides this data centrally for retrieval. For example, the data consumers KA, KB . . . can register for an automatic output service. Then data output is carried out regularly in a similar way to a standing order. In addition to registration, authentication can also be provided at the output interface OUT, so that unauthorised consumers are excluded from data retrieval. It can be provided that on registering for the events, each consumer that registers can define filters which relate, for example, to event IDs, time stamps etc.

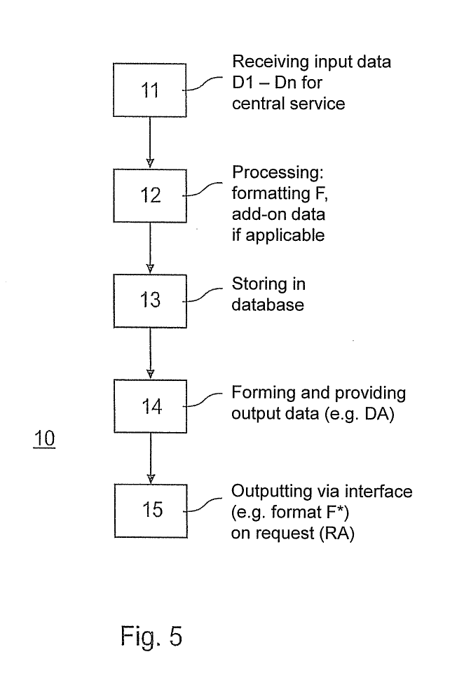

FIG. 5 shows in a flow diagram the essential steps of the method according to the invention. The method 10 comprises steps 11 to 15. In a first step 11, the input data D1-Dn (see also FIG. 4) is received by the central data unit. In a subsequent step 12, the data is processed and in particular is converted into a definable format. Furthermore, add-on data or metadata is added. Then in a step 13, the data is temporarily stored in a database. In a further step 14, output data is formed and provided, for instance the data DA (see FIG. 4). The actual output takes place in a step 15 by retrieval or request RA (see FIG. 4). The data output interface OUT also outputs the output data in a specific format F*.

To summarise, the invention proposes a central data service, which provides data relating to business events that occur in a business process for data consumers when requested or demanded. The data is provided in a processed form and via a defined output interface, and therefore the proposed system and method can be scaled very easily with respect to the growing number of consumers and the volume of data that occurs.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

1. A system for providing data containing information about business events that occur within a business process, wherein the system comprises a central data service unit, which receives on the input side, from business function units, input data containing information about the occurring business events, which processes the input data in order to form output data, and which provides on the output side, by means of a definable data output interface, the output data for retrieval by external data consumers.

2. The system according to claim 1, wherein the central data service unit comprises a first module, which receives the input data from the business function units by means of a definable data input interface, in particular via push transmission.

3. The system according to claim 2, wherein the first module processes the input data by conversion into a definable format, in particular into a format suitable for database applications.

4. The system according to claim 2, wherein the first module processes the input data by adding add-on data, in particular metadata.

5. The system according to claim 1, wherein the central data service unit comprises a second module, which stores the processed input data in a database.

6. The system according to claim 1, wherein the data output interface converts the output data into an output format for retrieval by the external data consumers, in particular converts said data for retrieval via pull transmission.

7. The system according to claim 5, wherein the second module, on each request by an external data consumer, controls the formation of the output data for the requesting data consumer, in particular controls the formation on the basis of the request.

8. The system according to claim 7, wherein the definable data output interface converts the output data for the requesting data consumer into the output format on the basis of the request.

9. The system according to claim 1, wherein the data output interface is designed.

10. A method for providing data containing information about business events that occur within a business process, comprising wherein the following steps are carried out in a central data service:
receiving input data containing information about the occurring business events;
processing the input data for storage in a database;
storing the processed input data in the database;
forming and providing output data from the stored and processed input data for retrieval by external data consumers.
